(19) United States
(12) Patent Application Publication
(10) Pub. No.: US 2012/0195342 A1
(43) Pub. Date: Aug. 2, 2012

(54) Configuration for Multiwavelength Emission with a CO2 Laser

(76) Inventor: David B. Cohn, Torrance, CA (US)

(21) Appl. No.: 13/017,739

(22) Filed: Jan. 31, 2011

(51) Int. Cl. H01S 3/03

(52) U.S. Cl. 372/61

(57) ABSTRACT

Multiple independent electrode sets of a CO₂ gas laser are arranged in series within a single optical resonator with each electrode set energized by an independent power source. The total length of the electrode sets together and their maximum power are optimized for output energy at the weakest laser wavelength, and one or several of the independent electrode sets is turned off and/or their power reduced to achieve laser output on strong lines without damage to the laser optics. The total resonator length is chosen to produce an output laser beam with single transverse mode.

### STATEMENT REGARDING FEDERALLY SPONSORED RESEARCH OR DEVELOPMENT

### CROSS REFERENCE TO RELATED APPLICATION

### BACKGROUND OF THE INVENTION

This invention relates to the CO₂ gas laser and in particular to the high pulse energy, high pressure transverse discharge type.

The output pulse of the high pressure Transverse Electric Atmospheric (TEA) CO₂ gas laser typically takes the form of an intense short spike followed by a low intensity tail. At moderate gas fill pressures on the order of one atmosphere, the spike and tail can be of the order of 100 ns and 1 microsecond in length, respectively. At higher gas fill pressures of several atmospheres, the spike width can reduce to the order of tens of nanoseconds. The output spike is useful for radar ranging applications to detect solid targets and for spectroscopic interrogation of gases in the atmosphere. In spectroscopic applications, it is important to minimize output energy variation among the weak and strong laser wavelengths to maximize the effectiveness of the detection circuitry. Desirable pulse repetition rates are generally greater than about 200 Hz, 5 millisecond interpulse period. The specific application determines the desirable spike pulsewidth and operating pressure of the laser. Spike pulsewidth can also be tailored by optical chopping with electro-optic crystals, but that approach is wasteful of laser energy and reduces system efficiency, an important factor for many applications.

The optics of the TEA CO₂ laser generally include windows that seal the gas vessel, a total reflecting optic or grating external to the vessel at the rear of the laser and a partially reflecting output coupler at the front of the laser through which the laser beam is emitted. These four pieces of optics are subjected to the circulating laser radiation within the resonator which reflects off the total reflector or grating at one end and the partially reflecting output coupler at the other. The output coupler partially reflecting side, which experiences the full high peak power circulating intracavity flux, is composed of multiple thin film coatings to achieve the proper reflectivity over the relatively broad band that the laser is capable of emitting, typically 9.3 μm to 11.2 μm for the various isotopes of CO₂; and in spectroscopy, the entire emission band is used in one laser. Because of the multiple coatings, which may have residual absorption at laser wavelengths, and imperfections imparted during film deposition, the output coupler has the lowest damage threshold of the four optics in the resonator and is therefore the life limiting component. Damage usually takes the form of ablation of the coating giving rise to a distorted output transverse mode profile with increased beam divergence and greatly reduced laser output energy. Damage is irreversible and can only be remedied by replacement of the optic.

The agent of optical damage is the high peak power of the pulsed circulating flux within the laser resonator. The intensity level of this flux is determined by its pulselength, the level of laser discharge excitation, and the reflectivity of the output coupler. Shorter pulses have higher peak power than longer pulses; therefore, in order to avoid optical damage, laser designs are chosen in which the pulselength is longer than would otherwise be desired for the application.

Intracavity peak intensity rises quickly with increasing values of output coupler reflectivity; therefore, low values of reflectivity are preferred at the chosen operating wavelength, consistent with the requirement that the gain is well saturated for efficient extraction. For those CO₂ laser wavelengths that offer strong emission, low values of coupler reflectivity are optimum; whereas, for weak emission wavelengths, high values of reflectivity are optimum. However, use of a high reflectivity coupler on a strong line would lead to rapid optical damage and use of a low reflectivity coupler on a weak line would result in poor saturation of the transition leading to low, erratic output energy; and a very weak line would fail to be emitted at all. This problem is most apparent with laser gas mixtures of the two isotopes ¹²C¹⁶O₂ and ¹³C¹⁶O₂ which are employed in spectroscopy to expand the available emission wavelengths from 60 to over 100. In that case, the gains for weak lines of either isotope alone are even lower in the mixture, which problem can only be remedied by an increase in the laser gain length.

For the CO₂ TEA laser, gain length is defined by the length of the two electrodes between which the exciting plasma glow discharge is struck. Low gain, weak lines require much longer electrodes than those for high gain strong lines, and the stored discharge energy for long electrodes is generally much higher than for short electrodes because of the increased discharge volume that must be excited. The problem in the weak line case with long electrodes and high stored energy is that in the event of a discharge fault or high current localized arc, the electrode can ablate in a small area rendering it unusable.

The use of long electrodes for weak lines leads to long optical resonators which favor single transverse mode output. Single transverse modes have much lower beam divergence than multiple transverse modes providing much greater beam intensity per area and therefore greater target range. The problem with strong lines and their conventionally short electrodes is that it is not generally possible to achieve single mode output.

For a given set of electrodes with fixed separation and length, the plasma excitation energy can be reduced to some extent by reducing the discharge voltage, but only to a point. In general, the voltage can be adjusted over a range of only about 20% with the lower limit defined by the minimum voltage required to maintain a self-sustained pulsed discharge. For a typical capacitively driven discharge where energy input scales as the square of charge voltage, the 20% range of voltage adjustment gives an input energy adjustment of only 36%, insufficient to accommodate both strong and weak lines within the same optical resonator without damage to the output coupler, but suitable for gain tuning in small steps.

It is a simple matter to adjust the gain length and the excitation voltage in order to reach a condition where the output coupler will not damage for a single wavelength chosen from the ¹²C¹⁶O_{2,} ¹³C¹⁶O² CO₂, or mixed ¹²C¹⁶O₂ plus ¹³C¹⁶O₂ manifolds. However, for the important spectroscopic application mentioned above it is important to rapidly shift among all the available wavelengths, including the very weak and very strong. In that case, choosing a proper coupler reflectivity, gain length, and discharge excitation voltage in a single device is highly problematic.

The solution taken in this patent to the problem of obtaining laser output on both strong and weak lines without optical damage is to segment the discharge electrodes, with each segment powered separately, at the same or different voltage, and turned on or off independently to adjust the gain.

The use of segmented electrodes was investigated by J. A. Fox, “A double-electrode-pair pulsed laser”, Appl. Phys. Lett., vol. 37, 590-591 (1980) and by Y. E. Lihua, et al “Application of multiple-electrode pair TEA CO₂ laser to remote sensing”, SPIE journal vol 3888, 489-496 (2000). Both authors employ a double set of electrodes for the purpose of obtaining laser output pulse pairs with variable time separation. They do not consider the problem of optical damage when shifting from weak to strong wavelengths. A double set of electrodes was also investigated by D. Cohn and H. Komine, “Long pulse excimer laser excited by sequenced discharges”, IEEE J. Quant. Electron., vol QE-19, 786-788 (1983). The objective of their work was to achieve an effectively long discharge pulse in an excimer laser by firing first one discharge and then firing the second discharge after a short delay. Paetzel, et al., “System and method for segmented electrode with temporal voltage shifter”, Patent No. US2005/00581722 A1, Mar. 17, 2005 show a method similar to that used by Cohn and Komine to achieve the similar effect of variable excitation and laser emission pulselengths.

### SUMMARY OF THE INVENTION

The present inventor has recognized that efficient energy extraction on both strong and weak lines of the CO₂ TEA laser can be achieved without optical damage by use of two or more independently powered sets of electrodes to adjust the intracavity intensity in large steps.

The invention also recognizes that the multiple sets of electrodes can be of differing lengths and that they can be powered at differing voltages with a step adjustable power supply in order to provide fine control of output energy for numerous strong and weak lines and to adjust their output energies to be uniform.

The invention also recognizes that damage to the electrodes themselves by discharge faults or arcs can be eliminated by use of independent low power segments as opposed to a single long electrode that is powered by a single high power source.

The invention further recognizes that the output on both strong and weak lines can be achieved with the same length optical resonator designed to give single transverse mode output, and the resonator optics can be attached to a surrounding optically stiff structure attached to the laser vessel thereby avoiding the problem of a conventional long resonator for single mode emission on strong lines in which short electrodes and a short gas vessel require a cantilevered optical structure which is very difficult to stiffen.

The invention finally recognizes that the various electrode segments offer the possibility of inserting folding optics between them to achieve a compact laser structure.

These particular features and advantages may apply to only some embodiments falling within the claims and thus do not define the scope of the invention. The following description and figures illustrate a preferred embodiment of the invention. Such an embodiment does not necessarily represent the full scope of the invention, however. Furthermore, some embodiments may include only parts of a preferred embodiment. Therefore, reference must be made to the claims for interpreting the scope of the invention.

### BRIEF DESCRIPTION OF THE DRAWINGS

FIG. 1 is a schematic of two electrode sets placed within the same optical resonator and with each electrode set independently powered.

FIG. 2 is a schematic of three electrode sets placed within the same optical resonator with each electrode set independently powered.

### DESCRIPTION OF THE PREFERRED EMBODIMENT

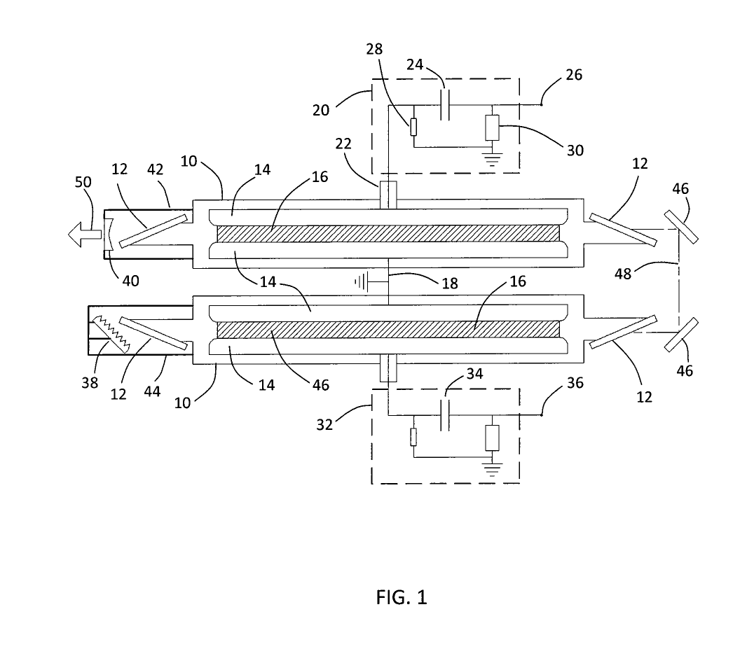

Referring to FIG. 1 of the drawings, there is shown two discharge modules placed side-by-side sharing the same optical resonator. Each module is composed of a gas vessel 10 with Brewster windows 12 to provide a vacuum seal at each end. Parallel electrodes 14 are arranged with a space between them to allow for a pulsed glow discharge 16 which pumps the gas, thereby providing the laser gain medium with length equal to the electrodes. One electrode of each module is grounded at position 18 and the other electrode is powered by an external, high voltage pulse circuit enclosed in the area indicated by dotted lines 20 and 32. The pulsers shown are the conventional capacitive discharge type. Referring to pulse circuit 20 for a description of its basic operation, capacitor 24 is charged by applying high voltage at terminal 26. Inductor or resistor 28 provides a high impedance ground path for charge current. After capacitor charging is complete, high voltage switch 30 is triggered and the inverted voltage is applied to the powered electrode. Power is fed from the pulser to the electrode through an insulated ceramic feedthrough 22. The pulse circuit of 32 is of similar construction except that capacitor 34 may be of a different value from capacitor 24 in order to adjust its stored energy. Likewise, the voltage applied at terminal 36 may differ from that applied to terminal 26 in order to further adjust stored pulse energy. For purposes of clarity, the illustration of FIG. 1 does not include a laser internal gas flow system and catalyst that would be required to achieve sustained high repetition rate operation. It would a simple extrapolation to house two or more electrode sets within the same gas vessel.

The optical resonator of FIG. 1 is composed of a grating 38 for wavelength selection at one end and a partial reflecting output coupler 40 at the other end. The coupler and grating are attached to the laser vessel, or alternatively to a surrounding rigid optical bench, by rigid holders 42 and 44, respectively. The intracavity beam 48 is routed between the two separate discharge modules by total reflecting turn mirrors 46. The two modules may be placed end-to-end without the optical fold, thereby eliminating the turn mirrors. Output beam 50 exits the resonator at the output coupler.

In operation, the output coupler reflectivity is chosen to optimize output energy on the weakest lines of the desired spectrum, and when selecting for the strongest lines it is necessary to turn off and/or reduce charge voltage for one of the discharge modules to reduce intracavity intensity and prevent optical damage. Using this protocol for one embodiment of the laser geometry shown in FIG. 1, operating at 650 Torr total gas pressure with a mixture containing both the ¹²_{C}¹⁶O₂, and ¹³C¹⁶O₂ isotopes in both discharge modules, 30 cm long electrodes of 1 cm width and separation in both modules, an energy of 5 J stored in 19 nF capacitors at 23 kV of each module pulser, and an 85% reflecting output coupler, the output energies are 150 mJ at 10.6 μm (a strong line attributed to ¹²C¹⁶O₂), 83 mJ at 9.77 μm (a very weak line attributed to ¹²C¹⁶O₂), 141 mJ at 10 μm (a weak line attributed to ¹³C¹⁶O₂), and 161 mJ at 11.02 μm (a very strong line attributed to ¹³C¹⁶O₂). This embodiment can be optimized for output on only strong lines without optical damage using a 75% reflecting output coupler (and approximately factor of two reduction in intracavity intensity compared to the 85% reflecting coupler), that is with both discharge modules firing at full power, in which case output energy at 11.02 μm is 338 mJ for the ¹²C¹⁶O₂ plus ¹³C¹⁶O₂ mixed isotopes and it is 456 mJ at 10.6 μm with the ¹²C¹⁶O₂ isotope alone. The weak lines at 9.77 μm and 10 μm do not lase with the 75% reflecting coupler. The output on all lines for the cases described above is in single transverse mode with a divergence of 1.5-1.7 mrad, approximately 1.3 times the diffraction limit.

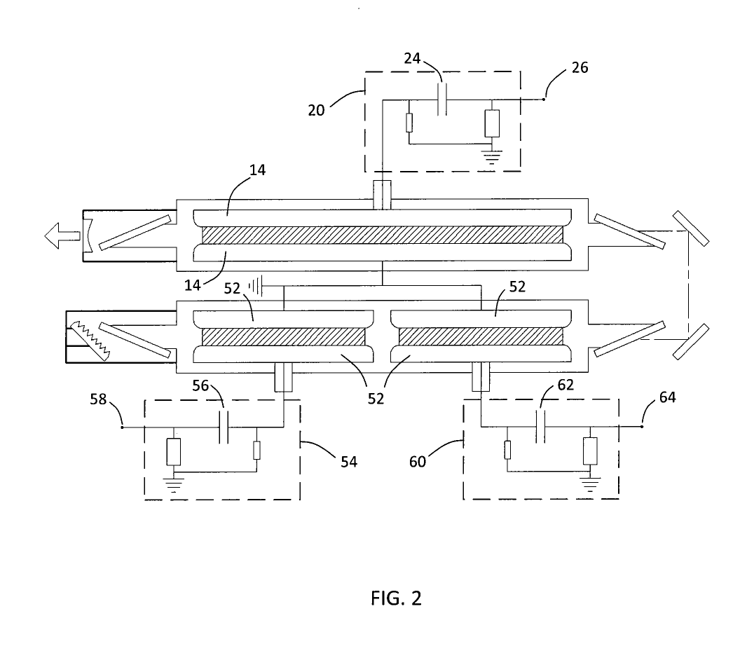

Referring to FIG. 2 of the drawings, there is shown three discharge modules sharing the same optical resonator. Electrodes 52 are half the length of electrodes 14, providing the option of firing discharge gain lengths equal to 0.5, 1, 1.5, and 2 times the length of electrodes 14. The three pulser circuits enclosed in dotted lines 20, 54, and 60 contain capacitors 24, 56, and 62, respectively, all of which may have the same or different values and charged to the same or different voltages applied at terminals 26, 58, and 64, respectively, to achieve finer control over output energy than could be achieved by selectively firing one, two, or three of the discharge gain modules. By selection of which discharge gain modules fire and their input pulsed power, uniformity of output energy among strong, weak, and very weak laser wavelengths is achieved without damage to the output coupler.

In summary, high levels of output energy on normally strong, weak, and very weak laser wavelengths, for gas mixtures containing the ¹²C¹⁶O₂ isotope alone, the ¹³C¹⁶O₂ alone, or mixtures of both isotopes together at total gas pressures suitable for the desired pulselength, can be achieved without optical damage to the output coupler by the placement of two or more sets of discharge electrodes within a single optical resonator, with the electrodes having the same or different lengths, and having the firing electrodes and their input power set differently for the strong, weak, and very weak laser wavelengths. The output beam in all cases is single transverse mode. This method of intracavity intensity control for strong and weak lines by selective pumping of segmented gain sections is applicable to all lasers where the unpumped laser sections do not exhibit absorption at the lasing wavelength, and in particular to the high pressure TEA CO₂ laser pumped by a pulsed transverse discharge or to the low pressure CO₂ laser pumped by a longitudinal discharge.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawing. All of these different combinations constitute various alternative aspects of the present invention. The embodiments described herein explain the best modes known for practicing the invention and will enable others skilled in the art to utilize the invention.

What is claimed is:

1. A multi-wavelength gas laser comprising:
an optical resonator providing an optically resonant cavity between reflectors;
at least one vessel within the optical resonator holding a gas laser medium;
a first and second opposed pair of parallel discharge electrodes within the at least one vessel;
a power source communicating with first and second opposed pair of parallel discharge electrodes to simultaneously energize the first and second opposed pair of parallel discharge electrodes with independently controllable voltages.

2. The multi-wavelength gas laser of claim 1 wherein the independently controllable voltages are a function of a desired output wavelength of the laser.

3. The multi-wavelength gas laser of claim 2 wherein the desired output wavelength of the laser is controlled by a grating.

4. The multi-wavelength gas laser of claim 1 wherein the power source may further energize only one of the first and second opposed pair of parallel discharge electrodes.

5. The multi-wavelength gas laser of claim 1 wherein the vessels are filled with gas mixtures of mixed isotopes of CO₂.

6. The multi-wavelength gas laser of claim 1 wherein the first and second opposed pair of parallel discharge electrodes have different lengths measured along an axis substantially perpendicular to a separation between the electrodes of each pair.

7. The multi-wavelength gas laser of claim 6 wherein the different lengths have a ratio of more than 1:1.5.

8. The multi-wavelength gas laser of claim 7 wherein the different lengths are substantially 2:1 in ratio.

9. The multi-wavelength gas laser of claim 1 wherein at least one electrode pair has a length of greater than 10 cm measured along an axis of light propagation.

10. The multi-wavelength gas laser of claim 1 wherein the independently controllable different voltages are less than 25 kV.

11. The multi-wavelength gas laser of claim 1 wherein the reflectors are selected from the group consisting of: a partial reflector, a full reflector, and a grating.

12. A method of operating a multi-wavelength gas laser having an optical resonator providing an optically resonant cavity between reflectors, at least one vessel within the optical resonator holding a gas laser medium, a first and second opposed pair of parallel discharge electrodes within the at least one vessel. and a means for selecting a spectral output of the laser; the method comprising the steps of:
setting a wavelength of the spectral output of the laser;
simultaneously energizing the first and second opposed pair of parallel discharge electrodes with independently controllable different voltages according to the wavelength of spectral output to limit damage to the reflectors.
